(19) United States
(12) Patent Application Publication
(10) Pub. No.: US 2015/0187388 A1
(43) Pub. Date: Jul. 2, 2015

(54) INTELLIGENT RECORDING IN ELECTRONIC DEVICES

(71) Applicants: NATHAN R. ANDRYSCO, Chandler, AZ (US); ADEDAMOLA OMOTOSHO, San Jose, CA (US)

(72) Inventors: NATHAN R. ANDRYSCO, Chandler, AZ (US); ADEDAMOLA OMOTOSHO, San Jose, CA (US)

(21) Appl. No.: 14/141,345

(22) Filed: Dec. 26, 2013

(51) Int. Cl. G11B 27/034; H04N 5/91

(52) U.S. Cl. CPC G11B 27/034; H04N 5/91

(57) ABSTRACT

In one example a controller comprises logic, at least partially including hardware logic, configured to receive a signal from a remote device, and in response to the signal, modify at least one aspect of a recording signal received from a recording device. Other examples may be described.

### RELATED APPLICATIONS

None.

### BACKGROUND

The subject matter described herein relates generally to the field of electronic devices and more particularly to intelligent recording in electronic devices.

Many electronic devices include audio and/or video recording capabilities. For example, mobile electronic devices such as laptop computers, netbook style computers, tablet computers, mobile phones, electronic reader, and wearable electronic devices such as computer-equipped glasses include cameras and/or audio recording features. In certain settings, for example in public settings, these recording devices sometimes raise privacy issues. Accordingly systems and techniques to provide for intelligent recording in electronic devices may find utility.

### BRIEF DESCRIPTION OF THE DRAWINGS

The detailed description is described with reference to the accompanying figures.

FIGS. 1 is a illustrations of exemplary electronic devices which may be adapted to implement intelligent recording in accordance with some examples.

FIG. 2 is a schematic illustration of components of a recording device which may be adapted to implement intelligent recoding in accordance with some examples.

FIG. 3 is a high-level schematic illustration of an exemplary architecture to implement intelligent recording in accordance with some examples.

FIG. 4 is a high-level schematic illustration of an environment in which intelligent recording may be implemented in accordance with some examples.

FIGS. 5A and 5B are flowcharts illustrating operations in a method to implement intelligent recording in accordance with some examples.

FIGS. 6-10 are schematic illustrations of electronic devices which may be adapted to implement intelligent recording in accordance with some examples.

### DETAILED DESCRIPTION

Described herein are exemplary systems and methods to implement intelligent recording in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

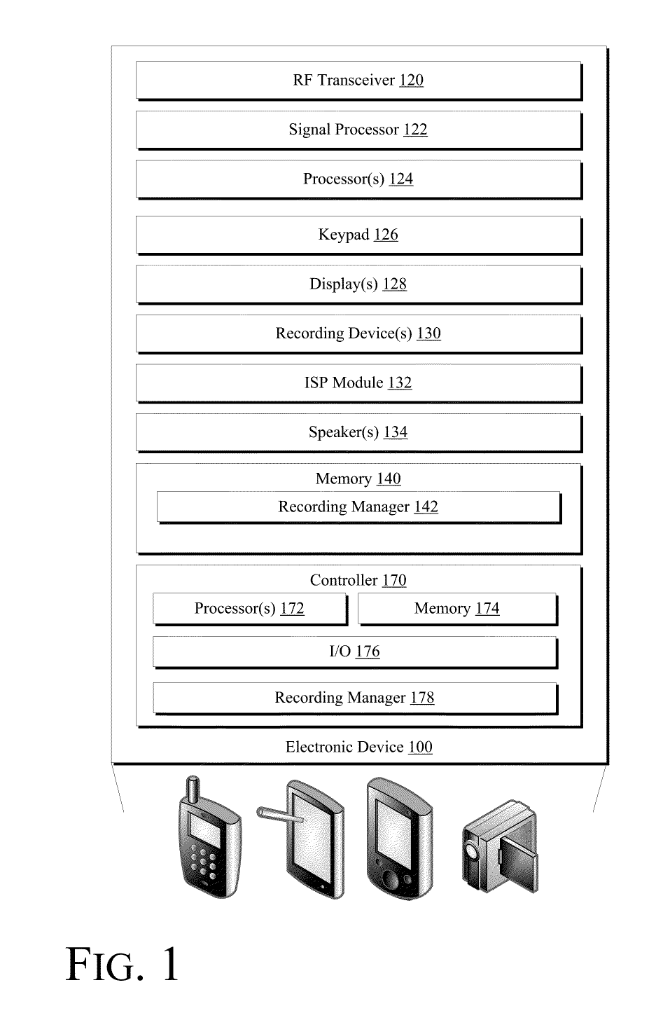

Briefly, the subject matter described here addresses the concerns set forth above at least in part by providing a controller with logic which can receive a signal from a remote device, and in response to the signal, can modify at least one aspect of a recording activity. When embedded in an electronic device which includes a recording device, the controller may configure the electronic device to cease all recording activity within a geographic region and/or time frame. Alternatively, or in addition, the controller may configure the recording device to selectively blur or block out portions of images received by the recording device. Further, logic in the controller may configure the electronic device to transmit a signal to a remote device confirming that recording activity is being modified and/or to present an indicator that recording activity is being modified. Specific features and details will be described with reference to FIGS. 1-10, below.

FIG. 1 is a schematic illustration of another example of an electronic device 100 which may be adapted to implement intelligent recording. In some aspects electronic device 100 may be embodied as a mobile telephone, a tablet computing device, a personal digital assistant (PDA), a notepad computer, a video camera, a wearable device like a smart watch, smart wrist band, smart headphone, or the like. The specific embodiment of electronic device 100 is not critical.

In some examples electronic device 100 may include an RF transceiver 120 to transceive RF signals and a signal processing module 122 to process signals received by RF transceiver 120. RF transceiver 120 may implement a local wireless connection via a protocol such as, e.g., Bluetooth or 802.11X. IEEE 802.11a,b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 100 may further include one or more processors 124 and a memory module 140. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some examples, processor 124 may be one or more processors in the family of Intel® PXA27x processors available from Intel® Corporation of Santa Clara, Calif. Alternatively, other processors may be used, such as Intel's Itanium®, XEON™, ATOM™, and Celeron® processors. Also, one or more processors from other manufactures may be utilized. Moreover, the processors may have a single or multi core design.

In some examples, memory module 140 includes random access memory (RAM); however, memory module 140 may be implemented using other memory types such as dynamic RAM (DRAM), synchronous DRAM (SDRAM), and the like. Memory 140 may comprise one or more applications including a recording manager 142 which execute on the processor(s) 122.

Electronic device 100 may further include one or more input/output interfaces such as, e.g., a keypad 126 and one or more displays 128, speakers 134, and one or more recording devices 130. By way of example, recording device(s) 130 may comprise one or more cameras and/or microphones/An image signal processor 132 may be provided to process images collected by recording device(s) 130.

In some examples electronic device 100 may include a low-power controller 170 which may be separate from processor(s) 124, described above. In the example depicted in FIG. 1 the controller 170 comprises one or more processor(s) 172, a memory module 174, an I/O module 176, and a recording manager 178. In some examples the memory module 174 may comprise a persistent flash memory module and the authentication module 176 may be implemented as logic instructions encoded in the persistent memory module, e.g., firmware or software. The I/O module 176 may comprise a serial I/O module or a parallel I/O module. Again, because the adjunct controller 170 is physically separate from the main processor(s) 124, the controller 170 can operate independently while the processor(s) 124 remains in a low-power consumption state, e.g., a sleep state. Further, the low-power controller 170 may be secure in the sense that the low-power controller 170 is inaccessible to hacking through the operating system.

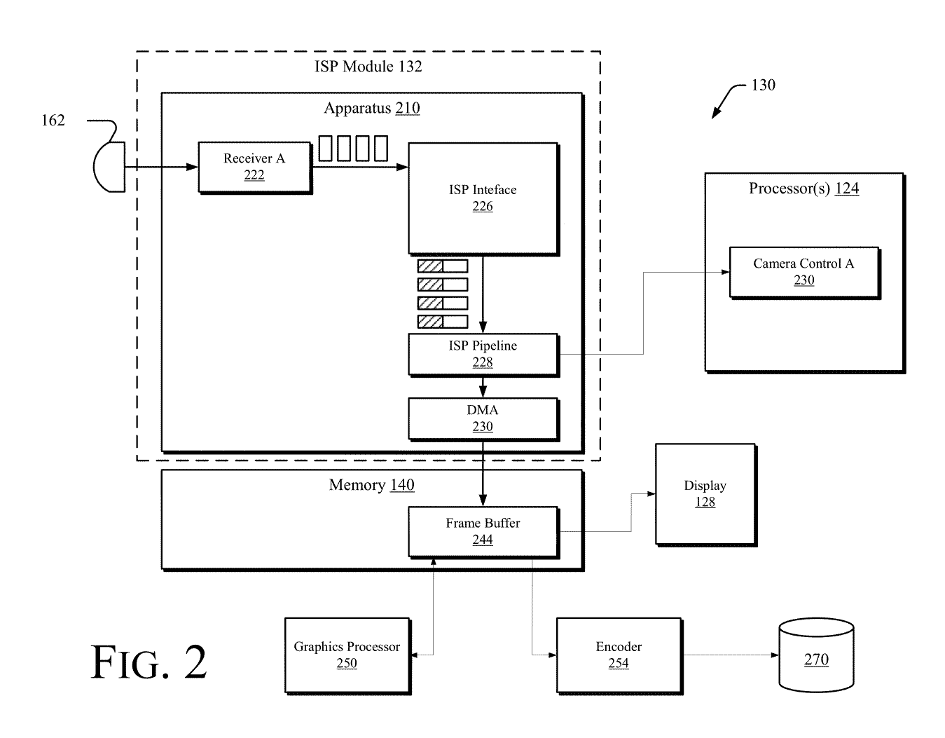

FIG. 2 is a schematic illustration of components of a recording device 130 which may be adapted to implement intelligent recoding in accordance with some examples. In the embodiment depicted in FIG. 2, the ISP module 132 comprises an image processing apparatus 210, which in turn comprises a camera receiver 222, an image signal processing interface 226, an image signal processing pipeline 228 and a direct memory access (DMA) engine 230. ISP module 132 is coupled to, or may include, the memory module 140 of electronic device 10. Memory module 140 maintains a frame buffer 242. Memory module 140 is coupled to a graphics processor 250 and an encoder 254. The processor module 124 of electronic device 100 may execute logic instructions for camera control unit 230 and, which controls operating parameters of the camera.

In operation, images from a camera 162 are input into receiver 222. In some embodiments camera 162 may comprise an optics arrangement, e.g., one or more lenses, coupled to an image capture device, e.g., a charge coupled device (CCD) or complementary MOS (CMOS) device. The output of the capture device may be in the format of a Bayer frame. The Bayer frames output from the CCD or CMOS device may be sampled in time to produce a series of Bayer frames, which are directed into receiver 222. These unprocessed image frames may sometimes be referred to herein as raw frames. One skilled in the art will recognize that the raw image frames may be embodied as an array or matrix of data values corresponding to the outputs of the CCD or CMOS device in the camera modules 162.

The raw Bayer frames are input to an ISP interface 226, which combines the image data in the raw Bayer frames. The ISP interface 226 forwards the lines of image data to the ISP pipeline 228, which processes the lines of image data. In some embodiments ISP pipeline 228 processes the raw image data to generate a YUV frame. The image is stored in a memory location and/or may be displayed on a suitable display module. For example, DMA module 230 may store the YUV frame in a frame buffer 242. A graphics processor 250 may process the image for presentation on a display module. The processed image may be stored in a frame buffer 244. The processed image may then be output to a display controller 252, which presents the image on a display 128. Further, the YUV image in frame buffer 244 may be forwarded to an encoder 254, which encodes the frame for multi-view encoding. The encoded frame may be stored in a suitable storage medium 270.

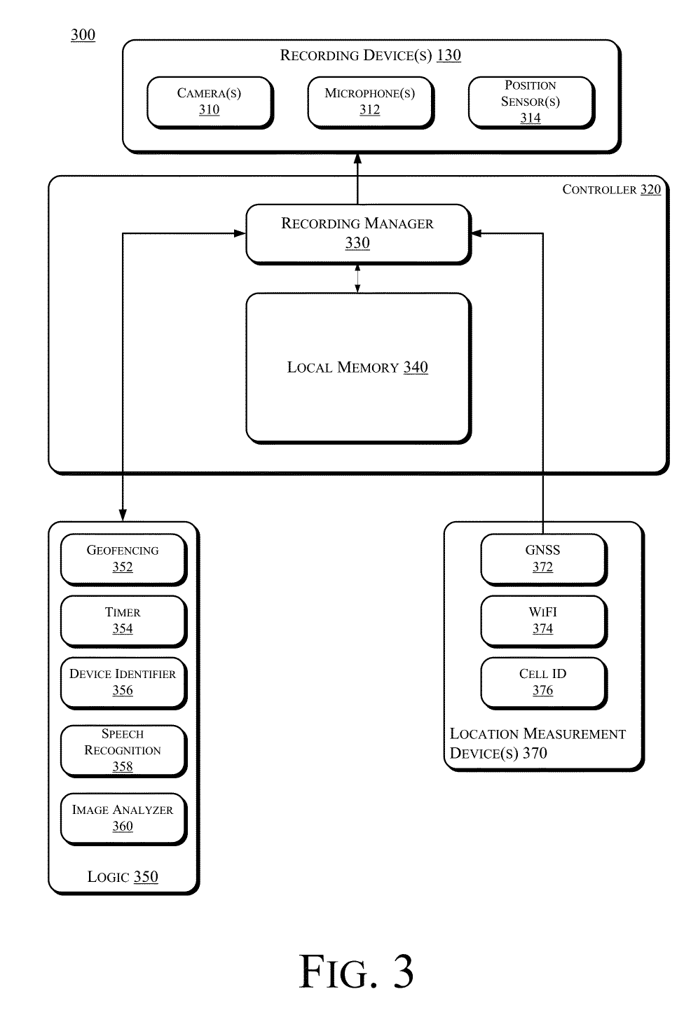

FIG. 3 is a high-level schematic illustration of an exemplary architecture 300 to implement intelligent recording in electronic devices. Referring to FIG. 3, a controller 320 may be embodied as general purpose processor such as processors 124 or as a low-power controller such as controllers 270. Controller 320 may implement a recording manager 330 to manage recording operations implemented by recording device which may be embedded in an electronic device. By way of example, recording manger 330 may manage the operations of one or more recording devices 130 in an electronic device 100.

Controller 320 may be communicatively coupled to one or more recording devices such as one or more cameras 310, microphones 312, or position sensor(s) 314 and to logic components 350 which provide information that may be used to manage a recording device. For example, logic components 350 may include a geofencing logic 352, a timer 354, a device identifier 356, a speech identifier 358, and an image analyzer 360.

Controller 320 may also be communicatively coupled to one or more location measurement devices 370, which may include a GNSS device 372, a WiFi device 374 and a cellular network device 376. GNSS device 372 may generate location measurements using a satellite network such as the Global Positioning System (GPS) or the like. WiFi device 374 may generate location measurements based on a location of a WiFi network access point. Similarly, Cell ID device 376 may generate location measurements base on a location of a cellular network access point.

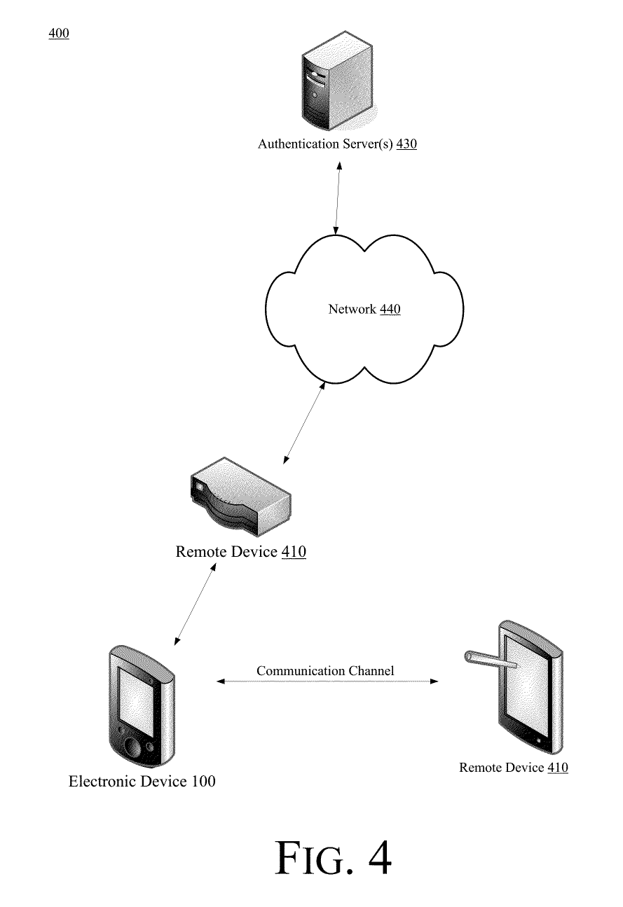

FIG. 4 is a high-level schematic illustration of an environment in which intelligent recording may be implemented in accordance with some examples. Referring to FIG. 4, in some environments an electronic device 100 as described above may be operating in a multi-device environment such as a public space. For example, electronic device 100 may be within range to establish a communication channel with one or more remote devices 410 which may also be embodied as an electronic device. For example, the communication channel between electronic device 100 and remote device 410 may be a wireless communication channel, an optical communication channel, or the like.

Electronic device 100 may also be coupled to a remote device 410 by a communication channel. For example, remote device 410 may be embodied as a network access device which provides electronic device 100 with access to one or more network resources 430 via a communication network(s) 440. For example, remote device 410 may be embodied as a wireless network access point and network(s) 440 may include wireless networks, e.g., wireless local area networks, and one or more public networks such as the Internet.

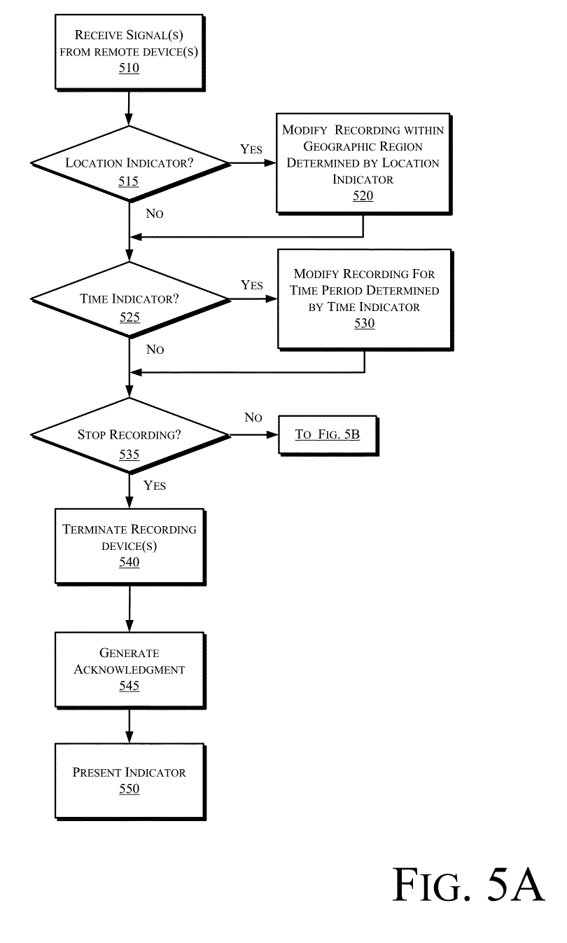

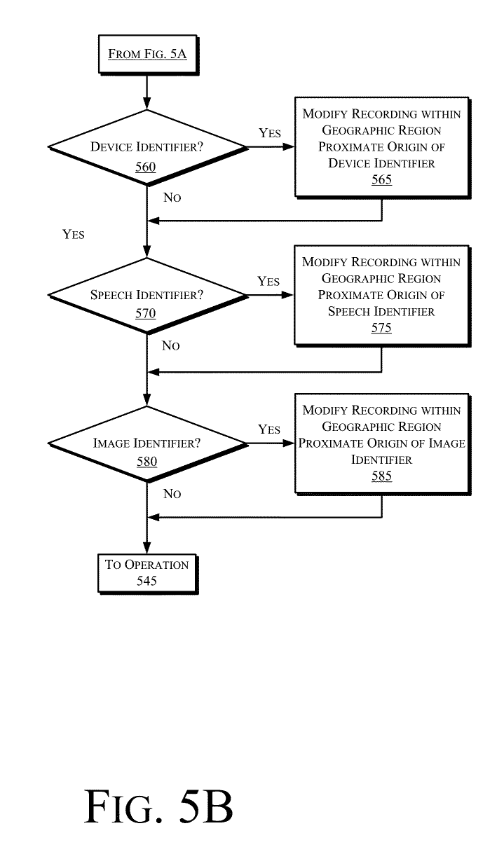

Having described various structures to implement intelligent recording in electronic devices, operating aspects will be explained with reference to FIGS. 5A-5B, which are flow charts illustrating operations in a method to implement intelligent recording in electronic devices. Some operations depicted in the flowchart of FIGS. 5A-5B may be implemented by the recording manager 330.

Referring first to FIG. 5A, at operation 510 the recording manager 330 receives one or more signal configuration conditions. FIG. 5A is a flowchart illustrating operations implemented by signal manager 330 in an electronic device 300. Referring to FIG. 4, at operation 510 the recording manager 330 receives one or more signals from one or more remote devices. For example, referring briefly to FIG. 4, in some examples the electronic device 100 may receive a signal from one or both of remote devices 410. The signal may be reported to recording manager 330.

If, at operation 515, the signal received at operation 510 includes a location indicator then control passes to operation 520 and the recording manager 330 modifies recording within a geographic region determined by the location indicator received with the stop recording signal in operation 510. By way of example, the remote device 410 may periodically broadcast a stop recording signal that includes a location indicator such as one or more Global Positioning System (GPS) coordinates. The stop recording signal may further include information such as a distance parameter. In response to the stop recording signal the recording manager 330 may invoke the services of geofencing module 352 to determine a geographic boundary in which the recording device(s) 130 are to be disabled. For example, the geofencing module 352 may determine a geofence defined as a circle centered at the GPS coordinates identified in the location indicator and having a radius corresponding to the distance parameter. Recording manager 330 then may invoke the services of one or more of the location measurement devices 370 to determine a current location of the electronic device 100 and terminates recording while the electronic device 100 is within the geofence boundary.

By contrast, if at operation 515 the signal received at operation 510 does not include a location indicator then control passes to operation 525.

If, at operation 525, the signal received at operation 510 includes a time indicator then control passes to operation 530 and the recording manager 330 modifies recording for a time period determined by the time indicator received with the stop recording signal in operation 510. By way of example, the remote device 410 may periodically broadcast a stop recording signal that includes a time indicator such as one or more times during which recording is not to be permitted in a region proximate the remote device 410. In response to the stop recording signal the recording manager 330 may invoke the services of timer 354 to determine a time period in which the recording device(s) 130 are to be disabled or otherwise modified.

By contrast, if at operation 535 the signal received at operation 510 does not include a time indicator then control passes to operation 540.

If, at operation 535, the signal received at operation 510 does not include a stop recording indicator then control passes to the operations depicted in FIG. 5B, described below. By contrast if the signal received at operation 510 includes a stop recording indicator then control passes to operation 540 and the recording manager 330 330 terminates recording device(s) 130 as long as the electronic device 110 is within range to receive a signal from remote device 410.

At operation 545 electronic device 100 generates an acknowledgment signal which confirms that recording operations have been terminated. The acknowledgment signal may be transmitted to remote device 410 via the communication channel between the devices. In examples in which remote device 410 provides a service such as network access to electronic device 100, remote device 410 may condition the provision of service on compliance by electronic device 100 with the recording device limitation policies asserted by remote device 410. Thus, if remote device 410 does not receive the acknowledgment signal from electronic device 100 then remote device 410 may refuse to provide electronic device 100 with network access privileges.

At operation 550 the electronic device 100 presents an indicator that recording activity is being modified. By way of example, electronic device 100 may present a visual indicator on display(s) 128, alone or in combination with an audible indicator on speaker(s) 134. Alternatively, electronic device 100 may illuminate an output device such as a light emitting diode (LED).

Thus, the operations depicted in FIG. 5A enable the recording manager 330 to modify or stop the recording device(s) 130 from recording in predetermined geographic regions and/or time periods in response to a signal from a remote device 410-2.

In some examples the recording manager 330 may allow the recording device(s) 130 to continue recording, but may block, blur or otherwise modify recording activity in response to a signal from a remote device 410. For example, if at operation 515 the signal received from the remote device 410 does not include a stop recording indicator then control passes to the operations depicted in FIG. 5B.

Referring to FIG. 5B, if at operation 560 the signal received at operation 510 includes a device identifier then control passes to operation 565 and the recording manager 330 modifies recording within a geographic region proximate the origin of the device identifier. By way of example, a remote device 410 may periodically broadcast a modify recording signal that includes a device identifier such as a character string or the like. In response to the signal the recording manager 330 may invoke the services of device identifier logic 356 to identify and locate the remote device 410 transmitting the modify recording signal. Once the remote device associated with the modify recording signal has been located the recording manager 330 may modify recording operations in a geographic region proximate the remote device 410 that originated the signal. For example, the recording manager may instruct the ISP module 132 to block, blur or otherwise modify portions of images in a region proximate the electronic device 410 which originated the signal.

By contrast, if at operation 560 the signal received at operation 510 does not include a device identifier then control passes to operation 570.

If, at operation 570 the signal received at operation 510 includes a speech identifier then control passes to operation 575 and the recording manager 330 modifies recording within a geographic region proximate the origin of speech corresponding to the speech identifier. By way of example, the electronic device may monitor sounds in the ambient environment and may invoke the services of speech recognition logic 358 to determine whether speech originating from a source in the ambient environment corresponds to the speech identifier received in the signal at operation 510. Once speech associated with the signal received at operation 510 has been located the recording manager 330 may modify recording operations in a geographic region proximate the source that originated the signal. For example, the recording manager may instruct the ISP module 132 to block, blur or otherwise modify portions of images in a region proximate source of the speech which originated the signal.

By contrast, if at operation 570 the signal received at operation 510 does not include a device identifier then control passes to operation 580.

If, at operation 580 the signal received at operation 510 includes an image identifier then control passes to operation 575 and the recording manager 330 modifies recording within a geographic region proximate the origin of an image corresponding to the image identifier. By way of example, the image identifier may be an image of a face or other characteristic feature and the electronic device 100 may invoke the services of an image recognition logic 360 to determine whether an image in a recording corresponds to the image identifier received in the signal at operation 510. Once an image associated with the signal received at operation 510 has been located the recording manager 330 may modify recording operations in a geographic region proximate the image. For example, the recording manager may instruct the ISP module 132 to block, blur or otherwise modify portions of recorded images in a region proximate source of the image which originated the signal.

By contrast, if at operation 580 the signal received at operation 510 does not include a device identifier then control passes back to operation 545.

Thus, the operations depicted in FIG. 5B enable the recording manager 330 to modify a recording in response to a signal from a remote device 410.

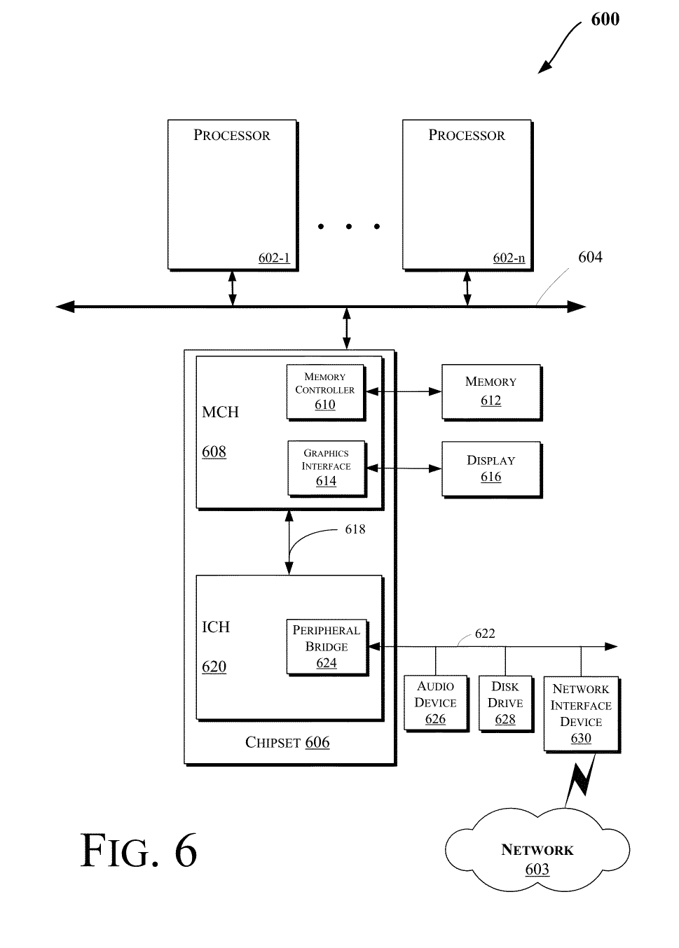

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

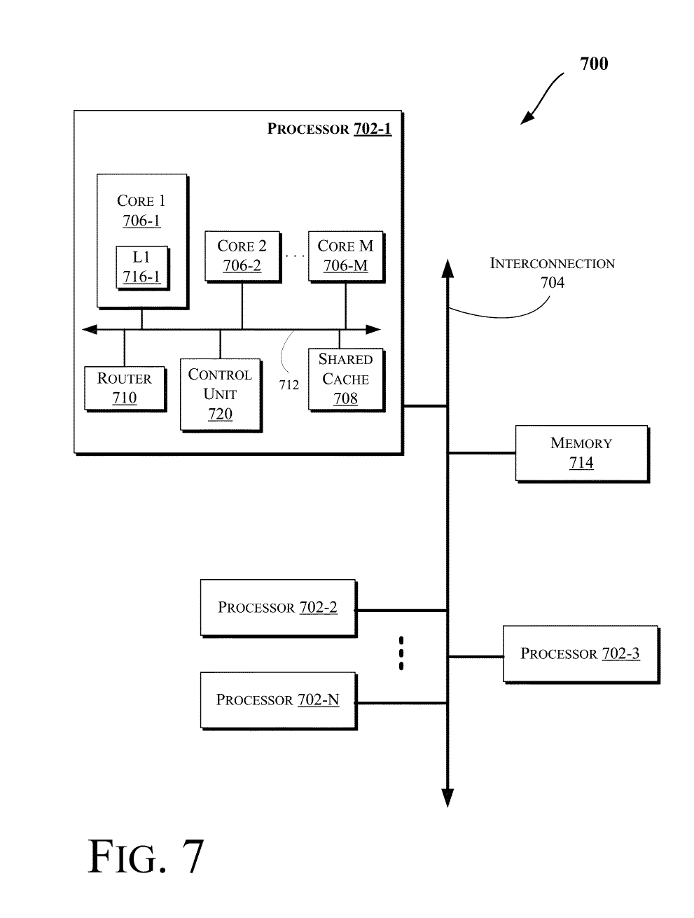

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

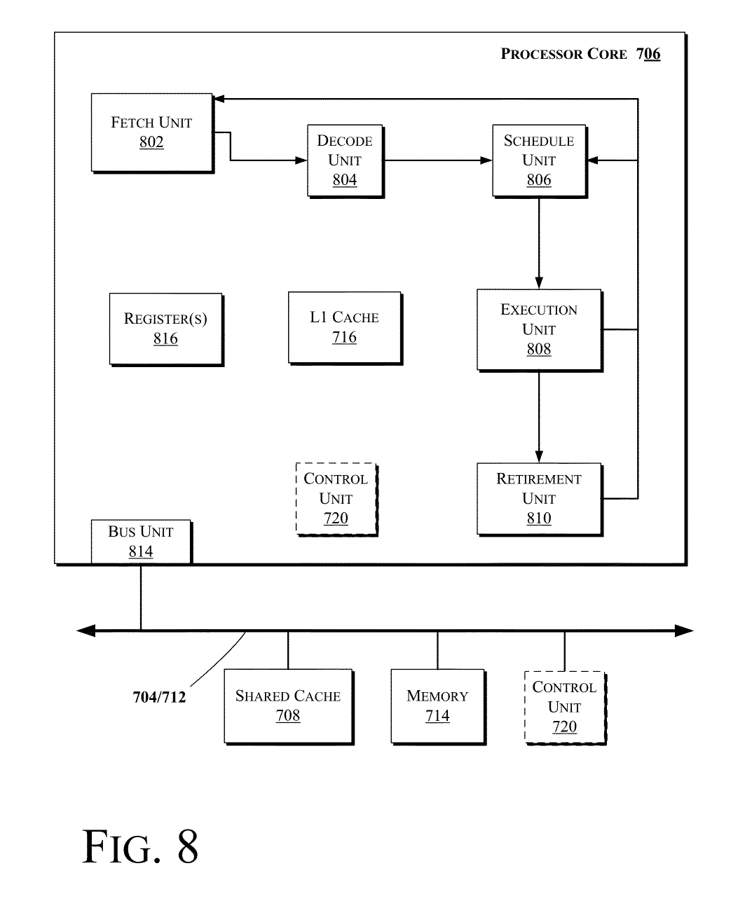

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

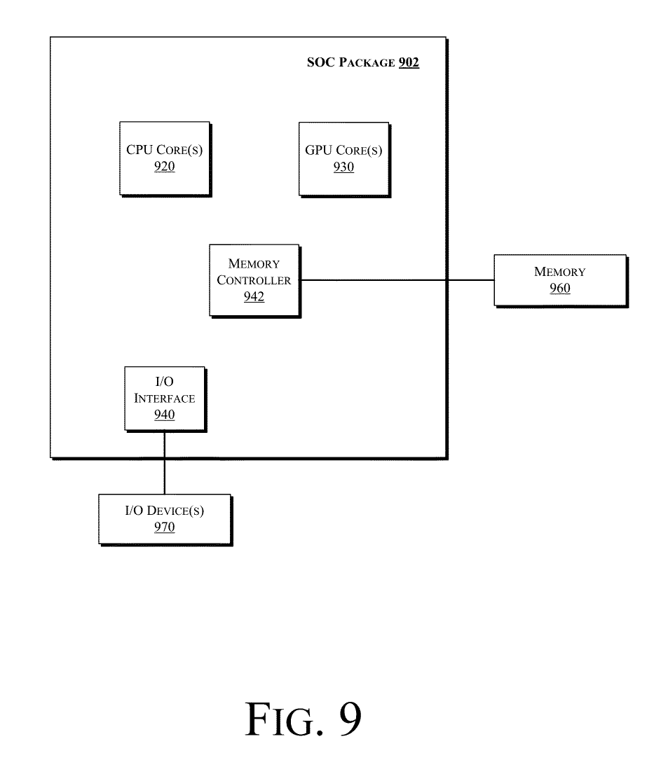

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

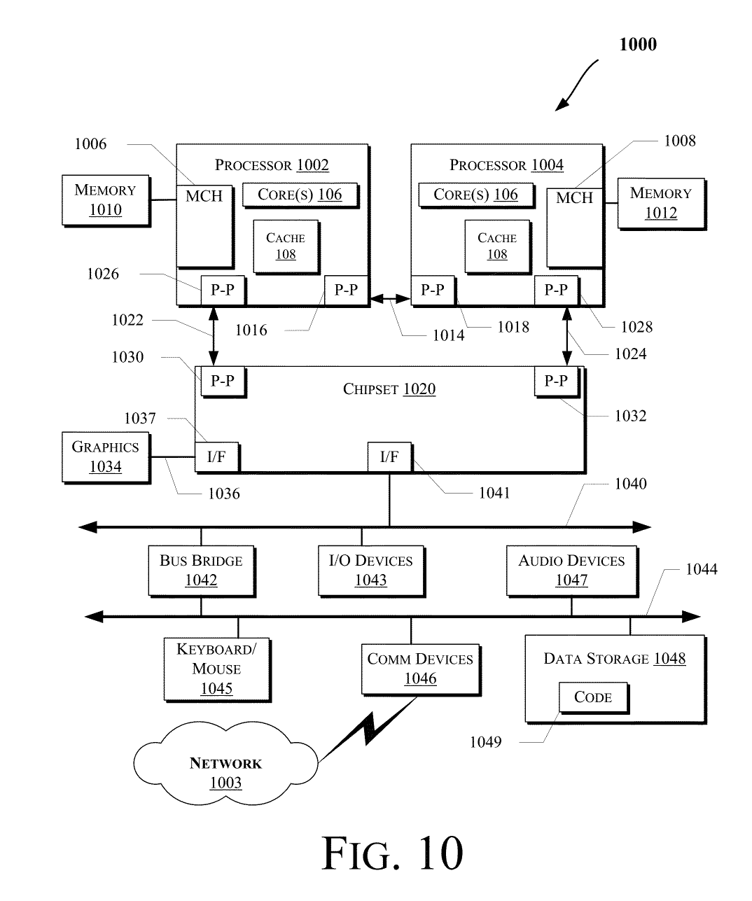

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertain to further examples.

Example 1 is a controller comprising logic, at least partially including hardware logic, configured to receive a signal from a remote device, and in response to the signal, modify at least one aspect of a recording signal received from a recording device.

In Example 2, the subject matter of Example 1 can optionally include an arrangement in which the signal further comprises a location indicator, and in response to the signal the logic configures the recording device to modify a signal from the recording device while the recording device is within a geographic region determined by the location indicator.

In Example 3, the subject matter of any one of Examples 1-2 can optionally include an arrangement in which the signal further comprises a time indicator, and in response to the signal the logic configures the recording device to modify a signal from the recording device from recording for a period of time determined by the time indicator.

In Example 4, the subject matter of any one of Examples 1-3 can optionally include an arrangement in which the signal comprises a do not record indicator and in response to the signal, the logic configures the recording device to stop recording.

In Example 5, the subject matter of any one of Examples 1-4 can optionally include an arrangement in which the signal further comprises a device identifier, and in response to the signal the logic configures the recording device to blur at least a portion of the recording in a geographic region proximate a device associated with the device identifier.

In Example 6, the subject matter of any one of Examples 1-5 can optionally include an arrangement in which the signal further comprises a speech identifier and in response to the signal, the logic configures the recording device to blur at least a portion of the recording in a geographic region proximate an origin of speech which corresponds to the speech identifier.

In Example 7, the subject matter of any one of Examples 1-6 can optionally include an arrangement in which the signal further comprises an image identifier and in response to the signal, the logic configures the recording device to blur at least a portion of the recording in a geographic region proximate an image which corresponds to the image identifier.

In Example 8, the subject matter of any one of Examples 1-7 can optionally logic, at least partially including hardware logic, configured to transmit a signal to the remote device to confirm that the recording activity is being modified.

In Example 9, the subject matter of any one of Examples 1-8 can optionally include an arrangement in which the remote device comprises a network access node and wherein, in response to the signal, the remote device is to authorize the controller to access a network via the network access node.

In Example 10, the subject matter of any one of Examples 1-9 can optionally logic, at least partially including hardware logic, configured to present an indicator that the recording activity is being modified.

Example 11 is an electronic device, comprising a recording device and a controller comprising logic, at least partially including hardware logic, configured to receive a signal from a remote device, and in response to the signal, modify at least one aspect of a recording signal received from a recording device.

In Example 12, the subject matter of Example 11 can optionally include an arrangement in which the signal further comprises a location indicator, and in response to the signal the logic configures the recording device to modify a signal from the recording device while the recording device is within a geographic region determined by the location indicator.

In Example 13, the subject matter of any one of Examples 11-12 can optionally include an arrangement in which the signal further comprises a time indicator, and in response to the signal the logic configures the recording device to modify a signal from the recording device from recording for a period of time determined by the time indicator.

In Example 14, the subject matter of any one of Examples 11-13 can optionally include an arrangement in which the signal comprises a do not record indicator and in response to the signal, the logic configures the recording device to stop recording.

In Example 15, the subject matter of any one of Examples 11-14 can optionally include an arrangement in which the signal further comprises a device identifier, and in response to the signal the logic configures the recording device to blur at least a portion of the recording in a geographic region proximate a device associated with the device identifier.

In Example 16, the subject matter of any one of Examples 11-15 can optionally include an arrangement in which the signal further comprises a speech identifier and in response to the signal, the logic configures the recording device to blur at least a portion of the recording in a geographic region proximate an origin of speech which corresponds to the speech identifier.

In Example 17, the subject matter of any one of Examples 11-16 can optionally include an arrangement in which the signal further comprises an image identifier and in response to the signal, the logic configures the recording device to blur at least a portion of the recording in a geographic region proximate an image which corresponds to the image identifier.

In Example 18, the subject matter of any one of Examples 11-17 can optionally include logic, at least partially including hardware logic, configured to transmit a signal to the remote device to confirm that the recording activity is being modified.

In Example 19, the subject matter of any one of Examples 11-18 can optionally include an arrangement in which the remote device comprises a network access node and wherein, in response to the signal, the remote device is to authorize the controller to access a network via the network access node.

In Example 20, the subject matter of any one of Examples 11-19 can optionally include logic, at least partially including hardware logic, configured to present an indicator that the recording activity is being modified.

Example 21 is a computer program product comprising logic instructions stored on a tangible computer readable medium which, when executed by a controller, configure the controller to receive a signal from a remote device, and in response to the signal, modify at least one aspect of a recording signal received from a recording device.

In Example 22, the subject matter of Example 21 can optionally include an arrangement in which the signal further comprises a location indicator, and comprising logic instructions stored on a tangible computer readable medium which, when executed by the controller, configure the controller to a signal from the recording device while the recording device is within a geographic region determined by the location indicator.

In Example 23, the subject matter of any one of Examples 21-22 can optionally include an arrangement in which the signal further comprises a time indicator, and comprising logic instructions stored on a tangible computer readable medium which, when executed by the controller, configure the controller to modify a signal from the recording device from recording for a period of time determined by the time indicator.

In Example 24, the subject matter of any one of Examples 21-23 can optionally include an arrangement in which the signal comprises a do not record indicator and comprising logic instructions stored on a tangible computer readable medium which, when executed by the controller, configure the controller to stop recording.

In Example 25, the subject matter of any one of Examples 21-24 can optionally include an arrangement in which the signal further comprises a device identifier, and comprising logic instructions stored on a tangible computer readable medium which, when executed by the controller, configure the controller to blur at least a portion of the recording in a geographic region proximate a device associated with the device identifier.

In Example 26, the subject matter of any one of Examples 21-25 can optionally include an arrangement in which the signal further comprises a speech identifier and comprising logic instructions stored on a tangible computer readable medium which, when executed by the controller, configure the controller to blur at least a portion of the recording in a geographic region proximate an origin of speech which corresponds to the speech identifier.

In Example 27, the subject matter of any one of Examples 21-26 can optionally include an arrangement in which the signal further comprises an image identifier and comprising logic instructions stored on a tangible computer readable medium which, when executed by the controller, configure the controller to blur at least a portion of the recording in a geographic region proximate an image which corresponds to the image identifier.

In Example 28, the subject matter of any one of Examples 21-27 can optionally include logic instructions stored on a tangible computer readable medium which, when executed by the controller, configure the controller to transmit a signal to the remote device to confirm that the recording activity is being modified.

In Example 29, the subject matter of any one of Examples 21-28 can optionally include an arrangement in which the remote device comprises a network access node and and comprising logic instructions stored on a tangible computer readable medium which, when executed by the controller, configure the controller to authorize the controller to access a network via the network access node.

In Example 30, the subject matter of any one of Examples 21-29 can optionally include logic instructions stored on a tangible computer readable medium which, when executed by the controller, configure the controller to present an indicator that the recording activity is being modified.

Example 31 is an apparatus, comprising a recording device and means for receiving a signal from a remote device, and means, responsive to the signal, for modifying at least one aspect of a recording signal received from a recording device.

In example 32 the subject matter of Example 31 can optionally include an arrangement in which the signal further comprises a location indicator, and comprising means responsive to the signal to configure the recording device to modify a signal from the recording device while the recording device is within a geographic region determined by the location indicator.

In Example 33, the subject matter of any one of Examples 31-32 can optionally include an arrangement in which the signal further comprises a time indicator, and further comprising means responsive to the signal to configure the recording device to modify a signal from the recording device from recording for a period of time determined by the time indicator.

In Example 34, the subject matter of any one of Examples 31-33 can optionally include an arrangement in which the signal comprises a do not record indicator and further comprising means responsive to the signal to configure the recording device to stop recording.

In Example 35, the subject matter of any one of Examples 31-34 can optionally include an arrangement in which the signal further comprises a device identifier, and further comprising means responsive to the signal to configure the recording device to blur at least a portion of the recording in a geographic region proximate a device associated with the device identifier.

In Example 36, the subject matter of any one of Examples 31-35 can optionally include an arrangement in which the signal further comprises a speech identifier and further comprising means responsive to the signal to configure the recording device to blur at least a portion of the recording in a geographic region proximate an origin of speech which corresponds to the speech identifier.

In Example 37, the subject matter of any one of Examples 31-36 can optionally include an arrangement in which the signal further comprises an image identifier and further comprising means responsive to the signal to configure the recording device to blur at least a portion of the recording in a geographic region proximate an image which corresponds to the image identifier.

In Example 38, the subject matter of any one of Examples 31-37 can optionally include means to transmit a signal to the remote device to confirm that the recording activity is being modified.

In Example 39, the subject matter of any one of Examples 31-38 can optionally include an arrangement in which the remote device comprises a network access node and further comprising means responsive to the signal to configure the recording device to authorize the controller to access a network via the network access node.

In Example 40, the subject matter of any one of Examples 31-39 can optionally include means to present an indicator that the recording activity is being modified.

Example 41 is a method, comprising receiving a signal from a remote device, and in response to the signal, modifying at least one aspect of a recording signal received from a recording device.

In Example 42, the subject matter of Example 41 can optionally include an arrangement in which the signal further comprises a location indicator, and further comprising modifying a signal from the recording device while the recording device is within a geographic region determined by the location indicator.

In Example 43, the subject matter of any one of Examples 41-42 can optionally include an arrangement in which the signal further comprises a time indicator, and further comprising modifying a signal from the recording device from recording for a period of time determined by the time indicator.

In Example 44, the subject matter of any one of Examples 41-43 can optionally include an arrangement in which the signal comprises a do not record indicator and further comprising stopping recording.

In Example 45, the subject matter of any one of Examples 41-44 can optionally include an arrangement in which the signal further comprises a device identifier, and further comprising blurring at least a portion of the recording in a geographic region proximate a device associated with the device identifier.

In Example 46, the subject matter of any one of Examples 41-45 can optionally include an arrangement in which the signal further comprises a speech identifier and further comprising blurring at least a portion of the recording in a geographic region proximate an origin of speech which corresponds to the speech identifier.

In Example 47, the subject matter of any one of Examples 41-46 can optionally include an arrangement in which the signal further comprises an image identifier and further comprising blurring at least a portion of the recording in a geographic region proximate an image which corresponds to the image identifier.

In Example 48, the subject matter of any one of Examples 41-47 can optionally include transmitting a signal to the remote device to confirm that the recording activity is being modified.

In Example 49, the subject matter of any one of Examples 41-48 can optionally include an arrangement in which the remote device comprises a network access node and further comprising authorizing the controller to access a network via the network access node.

In Example 50, the subject matter of any one of Examples 41-49 can optionally include presenting an indicator that the recording activity is being modified.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A controller, comprising:
logic, at least partially including hardware logic, configured to:
receive a signal from a remote device; and
in response to the signal, modify at least one aspect of a recording signal received from a recording device.

2. The controller of claim 1, wherein the signal further comprises a location indicator, and in response to the signal the logic configures the recording device to modify a signal from the recording device while the recording device is within a geographic region determined by the location indicator.

3. The controller of claim 1, wherein the signal further comprises a time indicator, and in response to the signal the logic configures the recording device to modify a signal from the recording device from recording for a period of time determined by the time indicator.

4. The controller of claim 1, wherein the signal comprises a do not record indicator and in response to the signal, the logic configures the recording device to stop recording.

5. The controller of claim 1, wherein the signal further comprises a device identifier, and in response to the signal the logic configures the recording device to blur at least a portion of the recording in a geographic region proximate a device associated with the device identifier.

6. The controller of claim 1, wherein the signal further comprises a speech identifier and in response to the signal, the logic configures the recording device to blur at least a portion of the recording in a geographic region proximate an origin of speech which corresponds to the speech identifier.

7. The controller of claim 1, wherein the signal further comprises an image identifier and in response to the signal, the logic configures the recording device to blur at least a portion of the recording in a geographic region proximate an image which corresponds to the image identifier.

8. The controller of claim 1, further comprising logic, at least partially including hardware logic, configured to transmit a signal to the remote device to confirm that the recording activity is being modified.

9. The controller of claim 8, wherein the remote device comprises a network access node and wherein, in response to the signal, the remote device is to authorize the controller to access a network via the network access node.

10. The controller of claim 1, further comprising logic, at least partially including hardware logic, configured to present an indicator that the recording activity is being modified.

11. An electronic device, comprising:
a recording device; and
a controller, comprising:
logic, at least partially including hardware logic, configured to:
receive a signal from a remote device; and
in response to the signal, modify at least one aspect of a recording signal received from a recording device.

12. The electronic device of claim 11, wherein the signal further comprises a location indicator, and in response to the signal the logic configures the recording device to modify a signal from the recording device while the recording device is within a geographic region determined by the location indicator.

13. The electronic device of claim 11, wherein the signal further comprises a time indicator, and in response to the signal the logic configures the recording device to modify a signal from the recording device from recording for a period of time determined by the time indicator.

14. The electronic device of claim 11, wherein the signal comprises a do not record indicator and in response to the signal, the logic configures the recording device to stop recording.

15. The electronic device of claim 11, wherein the signal further comprises a device identifier, and in response to the signal the logic configures the recording device to blur at least a portion of the recording in a geographic region proximate a device associated with the device identifier.

16. The electronic device of claim 11, wherein the signal further comprises a speech identifier and in response to the signal, the logic configures the recording device to blur at least a portion of the recording in a geographic region proximate an origin of speech which corresponds to the speech identifier.

17. The electronic device of claim 11, wherein the signal further comprises an image identifier and in response to the signal, the logic configures the recording device to blur at least a portion of the recording in a geographic region proximate an image which corresponds to the image identifier.

18. The electronic device of claim 11, further comprising logic, at least partially including hardware logic, configured to transmit a signal to the remote device to confirm that the recording activity is being modified.

19. The electronic device of claim 18, wherein the remote device comprises a network access node and wherein, in response to the signal, the remote device is to authorize the controller to access a network via the network access node.

20. The electronic device of claim 11, further comprising logic, at least partially including hardware logic, configured to present an indicator that the recording activity is being modified.

21. A computer program product comprising logic instructions stored on a tangible computer readable medium which, when executed by a controller, configure the controller to:
receive a signal from a remote device; and
in response to the signal, modify at least one aspect of a recording signal received from a recording device.

22. The computer program product of claim 22, wherein the signal further comprises a location indicator, and comprising logic instructions stored on a tangible computer readable medium which, when executed by the controller, configure the controller modify a signal from the recording device while the recording device is within a geographic region determined by the location indicator.

23. The computer program product of claim 22, wherein the signal further comprises a time indicator, and comprising logic instructions stored on a tangible computer readable medium which, when executed by the controller, configure the controller to modify a signal from the recording device from recording for a period of time determined by the time indicator.

24. The computer program product of claim 21 wherein the signal comprises a do not record indicator and comprising logic instructions stored on a tangible computer readable medium which, when executed by the controller, configure the controller to configures the recording device to stop recording.

25. The computer program product of claim 21, wherein the signal further comprises a device identifier, and comprising logic instructions stored on a tangible computer readable medium which, when executed by the controller, configure the controller to blur at least a portion of the recording in a geographic region proximate a device associated with the device identifier.
